(19) United States
(12) Patent Application Publication
(10) Pub. No.: US 2024/0134772 A1
(43) Pub. Date: Apr. 25, 2024

(54) Mobile Ticketing Device for a Transport Vehicle

(71) Applicant: Scheidt & Bachmann GmbH, Mönchengladbach (DE)

(72) Inventor: Thomas Müller, Mönchengladbach (DE)

(21) Appl. No.: 18/485,837

(22) Filed: Oct. 11, 2023

(30) Foreign Application Priority Data
Oct. 19, 2022 (DE) 10 2022 127 734.8

(51) Int. Cl. G06F 11/34; G06F 13/24

(52) U.S. Cl. CPC G06F 11/3495; G06F 13/24

(57) ABSTRACT

A mobile ticketing device for a transport vehicle of a passenger transport system includes at least one electrical connector equipment configured to connect the mobile ticketing device to an electrical on-board supply system of the transport vehicle and at least one electrical measuring module configured to measure an electrical parameter applied at the electrical connector equipment. Further included in the mobile ticketing device is at least one generation unit configured to generate at least one measurement data set containing at least one electrical parameter datum about the measured electrical parameter and at least one output module configured to output the generated measurement data set.

### CROSS-REFERENCE TO RELATED APPLICATIONS

This application claims the benefit of German patent application No. 10 2022 127 734.8, filed Oct. 20, 2022, the disclosures of which are incorporated herein by reference in their entirety.

### TECHNICAL FIELD

The application relates to a mobile ticketing device for a transport vehicle of a passenger transport system comprising at least one electrical connector equipment configured to connect the mobile ticketing device to an electrical system of the transport vehicle. Furthermore, the application relates to a passenger transport system and a method for monitoring a mobile ticketing device.

### BACKGROUND ART

A present passenger transport system, in particular a public passenger transport system, serves to transport passengers and users, respectively, by means of passenger transport vehicles (hereinafter referred to as transport vehicles). Exemplary and non-exhaustive transport vehicles of a passenger transport system are rail vehicles (e.g., suburban train, subway, streetcar etc.), motor vehicles (e.g., bus), but also water vehicles (e.g., ferry) and airplanes. A trip of a user with a transport vehicle from a trip start point to a trip end point is in particular referred to as a transport trip.

A ticket medium and ticket, respectively, is generally required for an authorized respectively permissible use of a transportation trip respectively a corresponding transportation service. The ticket medium can generally indicate that the user is authorized to perform the transport trip and to use the passenger transport system, respectively. In prior art passenger transportation systems, for example, paper tickets can be used as ticket media, which must be purchased at a ticketing device prior to the start of the trip.

In addition to stationary ticketing devices that do not move (during operation) and, for example, are permanently located in a stop area, such as a train station, etc., so-called mobile ticketing devices are known from the prior art.

A mobile ticketing device is in particular a ticket vending machine and/or a so-called farebox installed in a transport vehicle. In other words, a mobile ticketing device means in particular a ticket vending machine and/or farebox that is permanently installed in a transport vehicle. Mobile means in particular that the ticketing device, in contrast to a stationary ticketing device, can be moved by a transport vehicle in which it is in turn immovably fixed.

The advantage of mobile ticketing devices is that the installation of a plurality of stationary ticketing devices at a plurality of stops can be dispensed with. This can facilitate maintenance of the ticketing devices, as this can (always) be carried out in a vehicle depot respectively vehicle yard, for example. In addition, the risk of damage due to e.g., vandalism, can be reduced with mobile ticketing devices.

In order to supply a mobile ticketing device with electrical energy required for operation, known mobile ticketing devices have an electrical connector equipment configured to (electrically) connect the mobile ticketing device to the electrical on-board supply system of the transport vehicle.

The transport vehicle may, for example, comprise a rechargeable battery or, for example, a current collector which is configured to connect to a supply line (e.g., an overhead line). Electrical power can be supplied to the mobile ticketing device from the battery and/or the current collector or a similar power source, by means of the on-board supply system and the electrical connector equipment. An own energy source (e.g., a battery) and/or a buffering device is/are therefore also not present in a mobile ticketing device for reasons of space and cost.

In known mobile ticketing devices, (temporary) operational failures occur time and again. Such a failure regularly leads to a loss of revenue, as ticket sales are not possible during the failure of the mobile ticketing device. If an operational failure of a mobile ticketing device is detected by a service technician or another person, a search for a reason of the failure is carried out by a service technician. This involves a great deal of effort. In addition, it is suspected that a plurality of temporary operational failures of mobile ticketing devices go unnoticed and thus, in particular, are not remedied.

Therefore, it is desirable to create a possibility that enables a reduction of (temporary) operational failures of mobile ticketing devices and, in particular, a detection of failed mobile ticketing devices in a timely manner.

### SUMMARY OF THE INVENTION

According to a first aspect of the application, a mobile ticketing device for a transport vehicle of a passenger transport system has at least one electrical connector equipment. The electrical connector equipment is configured to (electrically) connect the mobile ticketing device to an electrical on-board supply system of the transport vehicle. The mobile ticketing device also has at least one electrical measuring module. The electrical measuring module is configured to measure an electrical parameter applied at the electrical connector equipment. The mobile ticketing device further includes at least one generator unit configured to generate at least one measurement data set containing at least one electrical parameter datum about the measured electrical parameter. The mobile ticketing device further includes at least one output module configured to output the generated measurement data set.

In that, in contrast to the prior art, the mobile ticketing device is provided, according to the application, with at least one electrical measuring module for measuring an electrical parameter applied at the electrical connector equipment and a subsequent (preferably automated) outputting of a measurement data set with at least one item of information about the measured electrical parameter, a possibility is provided which enables a reduction in the (temporary) operational failures of mobile ticketing devices and, in particular, a detection of failed mobile ticketing devices in a timely manner. The effort involved in detecting and remedying a failed mobile ticketing device is reduced.

In particular, it has been recognized that a main reason for an in particular temporary operational failure is not, or at least not only, the mobile ticketing device, but regularly the electrical on-board supply system respectively the electrical components of the transport vehicle connected thereto is/are a main reason. It has been shown, for example, that the electrical installation respectively the electrical on-board supply system of a transport vehicle is often very confusing. In particular, in older transport vehicles, grown cable routes, cable cross sections and/or interconnections of the different electrical consumers of the transport vehicle are often unclear and cannot be fully evaluated in all cases during an installation of the mobile ticketing device.

In addition, there are often the long cable paths of an on-board supply system from the transport vehicle's power source to the mobile ticketing device. This can result in the electrical parameters applied at the electrical connector equipment of the mobile ticketing device (in particular an input voltage) being in a range that is not permissible for the mobile ticketing device, i.e., in particular outside the design range for which the mobile ticketing device is designed. This can lead to a malfunction and in particular a failure of the mobile ticketing device.

It has been identified as particularly problematic that the “accidental” activation of at least one other (in particular powerful) consumer of the transport vehicle (e.g., fan, air conditioning system, hydraulic units, electric motors, etc.) during normal operation of an installed mobile ticketing device can lead to impermissible applied electrical parameters.

Mobile ticketing devices depend on an electrical power supply, in particular voltage supply, within predefined limits of specified standards for reliable operation. These limits define, in particular, the design range. If a voltage is outside the design range, at least one electrically operated component of the mobile ticketing device may temporarily fail to operate.

Since, according to the application, a monitoring arrangement comprising at least the electrical measuring module, the generation unit and the output module is integrated in the mobile ticketing device for monitoring an applied electrical parameter, operating failures due to an electrical parameter not being within the permissible design range can be detected (in a timely manner). Measures can then be taken (in a timely manner) to remedy the reason of the failure.

The mobile ticketing device according to the application is for use in a passenger transport system. A passenger transport system according to the application is in particular a public passenger transport system and serves to transport passengers and users, respectively, by means of passenger transport vehicles (hereinafter referred to as transport vehicles). Exemplary and non-exhaustive transport vehicles are rail vehicles (e.g., train, subway, streetcar, etc.), motor vehicles (e.g., bus), but also water vehicles (e.g., ferry) and airplanes.

As has already been described, a mobile ticketing device is to be understood in particular as a device for dispensing and/or validating ticket media that is permanently installed in a transport vehicle. A ticket medium that can be issued is in particular a paper-based ticket. Exemplary further ticket media that can be validated in particular by a mobile ticketing device are tokens, chip cards (or smart cards), credit cards, bank cards (or the like), cell phones, personal digital assistants (PDAs), tablet PCs, integrated circuit chips, electronic passports, electronic ID documents, etc.

In particular, a mobile ticketing device according to the application means a ticketing device with an average power consumption of at least 40 watts. Mobile ticketing devices with a lower power requirement, such as validating devices and validators, respectively, are in particular not mobile ticketing devices according to the present application.

Preferably, the mobile ticketing device is a ticket vending machine and/or a farebox, which in particular are permanently installed in a transport vehicle of the passenger transport system in an intended operation.

A mobile ticketing device may comprise at least one electrically powered component. Preferably, the mobile ticketing device may comprise as a component a printer (e.g., needle printer, thermal printer, or inkjet printer) in particular configured to print a ticket medium respectively a ticket. Alternatively or additionally, the mobile ticketing equipment may comprise an electrically operated money acceptance and exchange device in particular configured to accept coins and/or banknotes. For example, a money acceptance and (optionally) exchange equipment may comprise an electric motor as a drive for a banknote feeder. Alternatively or additionally, further electrically driven components may be integrated in a mobile ticketing device, such as at least one first contact-based and/or wireless-based interface configured to read a storage means of a ticket medium, at least one data memory configured to store at least one sales data set, at least one second wired-based and/or wireless-based interface configured to transmit the stored sales data sets, at least one graphical display (e.g., a driver display), etc.

Non-exhaustive examples of a first contact-based interface are magnetic stripes and Europay Mastercard VISA chips (EMV chips); examples of preferred first contactless interfaces are Nearfield Communication interfaces (NFC interfaces) according to ISO 14443. A preferred second interface may in particular be a WLAN (Wireless Local Area Network) interface.

The mobile ticketing device according to the application comprises at least one electrical connector equipment, which is used to electrically connect the on-board supply system of the transport vehicle and the at least one electrically operated component of the mobile ticketing device. An internal power network may be implemented between the electrical connector equipment and the at least one component.

The electrical connector equipment is in particular a power supply unit. In particular, the power supply unit serves to convert an electrical parameter provided by the on-board supply system with a certain value into a value required for the at least one electrically operated component. In particular, a voltage provided by the on-board supply system with a certain voltage value can be converted into a voltage value required for the at least one electrically operated component of the mobile ticketing device.

As has already been described, it is necessary for reliable and trouble-free operation of the mobile ticketing device that the at least one electrical parameter (in particular the voltage) applied at the electrical connector equipment is applied within predetermined parameter limits, which in particular define the design range. In addition to the design range, a lowest limit at which a shutdown always occurs and an uppermost limit at which a safety mechanism (e.g., a fuse) is always triggered can also be defined. For example, a permissible lowest limit of 9 V and a permissible highest limit of 40 V can be specified for the voltage.

In addition to an electrical connector equipment, the mobile ticketing device may also comprise at least one mechanical connector equipment configured to mechanically couple the mobile ticketing device to the transport vehicle. In other words, the mechanical connector equipment serves for the fixed respectively permanent mechanical attachment of the mobile ticketing device to respectively in the transport vehicle.

According to the application, the mobile ticketing device comprises at least one electrical measuring module configured to measure an electrical parameter respectively the corresponding parameter value applied at the electrical connector equipment. Particularly preferably, the electrical measuring module is a voltage measuring module configured to measure an (input) voltage respectively the corresponding voltage value applied at the electrical connector equipment.

Preferably, the electrical measuring module is integrated in the electrical connector equipment, i.e., in particular in the power supply unit of the mobile ticketing device.

Furthermore, the mobile ticketing device comprises a generation unit configured to generate at least one measurement data set containing at least one electrical parameter data about the measured electrical parameter. Preferably, the measurement data set may be a voltage measurement data set containing at least one voltage datum about the measured electrical voltage.

The parameter datum may be the measured parameter respectively its parameter value. Alternatively or additionally, the parameter datum may be an event triggered respectively caused by the measured parameter.

In variants of the application, the at least one electrical parameter may be an electrical parameter other than voltage, such as current.

The mobile ticketing device further comprises an output module configured to output the generated measurement data set. According to one embodiment, the output module may comprise respectively form a communication unit (e.g., the described second contact-based or contactless interface). In particular, the communication unit may be configured to transmit the at least one measurement data set to a further system respectively device, such as a background system of the passenger transport system and/or a mobile terminal (for example of a service technician) of the passenger transport system.

According to a preferred embodiment of the mobile ticketing device according to the application, the electrical measuring module may comprise a comparator circuit integrated in the connector equipment. The comparator circuit may be configured to compare the parameter value applied at the electrical connector equipment with at least one predetermined electrical threshold value. Preferably, the measured voltage may be compared with at least one voltage threshold value.

The comparator circuit may be configured to (temporarily) change a comparator state (only) upon a detection of an exceeding and/or falling below of the at least one electrical threshold value by the measured applied electrical parameter. In particular, the comparator state may be represented by a state bit. When the threshold value is exceeded and/or when it is fallen below, a bit change may occur (e.g., from 0 to 1 or from 1 to 0).

The comparator circuit can be configured to transmit a state change information to a computing equipment, comprising the generation unit, of the mobile ticketing device (only) when respectively immediately after a change of the comparator state has occurred. In particular, a computing equipment can be informed of a bit change that has taken place due to said threshold value being exceeded or fallen below.

Preferably, the state change information is merely an information that there has been a state change, without the state change information containing an information about the type of state change. A particularly easy-to-install and at the same time robust measuring equipment can be provided.

According to a particularly preferred embodiment of the mobile ticketing device according to the application, a plurality (preferably between 2 and 6, for example 4) of different electrical threshold values may be predetermined. In particular, the comparator circuit may be configured to compare the parameter value applied at the electrical connector equipment with at least two different predetermined electrical threshold values, preferably voltage threshold values, in particular with four different predetermined electrical threshold values, preferably voltage threshold values.

The comparator circuit may be configured to (temporarily) change the comparator state (only) upon a detection of an exceeding and/or falling below of a respective threshold value by the measured applied electrical parameter. Preferably, a state bit may be associated with each threshold value. In the example with four predetermined electrical threshold values, each of these threshold values may be assigned to a respective state bit. In particular, the changed comparator state depends on the respective threshold value that has been exceeded or fallen below. Thus, when the respective threshold value is exceeded and when it is fallen below, a bit change can occur (e.g., from 0 to 1 or from 1 to 0) in the state bit assigned to this threshold value. The comparator state is represented in particular by a bit pattern.

The comparator circuit may be configured to transmit the state change information to the computing equipment (only) at (or immediately after) each change of the comparator state. As has already been described, the state change information may preferably only be an information that there has been a state change (e.g., a bit change), without the state change information containing information about the type of state change (i.e., which state bit has changed, for example). In a simple and at the same time reliable manner, monitoring of the on-board supply system connection of the mobile ticketing device can be performed. In particular, a plurality of threshold values can be predefined at the factory. In a reliable manner, an evaluation of the quality of the network connection can be performed.

For example, the following four voltage thresholds may be implemented in the comparator circuit:
a. Lowest threshold 9 V (the absolute lowest voltage at which the power supply still operates),
b. Lower limit 11 V (if the voltage is lower than this for 12 V vehicles, then it can be concluded that the on-board supply system is of poor quality and failures may occur),
c. Lower limit 22 V (if the voltage is lower than this for 24 V vehicles, then it can be concluded that the on-board supply system is of poor quality and failures may occur),
d. Upper limit 40 V (if the voltage is higher, the power supply may be damaged).

According to a further embodiment, the comparator circuit, in particular an integrated circuit of the comparator circuit, may be connected to the computing equipment via a bus system. Particularly preferably, the bus system may be an I²C (Inter-Integrated Circuit) bus system. Such a bus system can be operated with a high reliability.

The bus system may comprise at least one interrupt line and one data line, and in particular a clock line. The comparator circuit, in particular the integrated circuit of the comparator circuit, may be configured to transmit the state change information to the computing equipment by sending an interrupt via the interrupt line.

In particular, an interrupt may cause an (immediate) interrupting of the current execution of a specific computing task (e.g., controlling of a component of the mobile ticketing device) of the computing equipment. Furthermore, the computing equipment may be configured to (immediately) initiate a transmission of the (respectively) changed comparator state via the data line to the computing equipment upon respectively immediately after a receipt of the interrupt.

In particular, the computing equipment as master in the I²C bus system can initiate the data transfer. The comparator circuit, in particular the integrated circuit of the comparator circuit, can respond to this as a slave in the I²C bus system and in particular transfer the comparator state (i.e., in particular the at least one state bit value (0 or 1). With a plurality of state bits, each state bit value can be transmitted in particular in the form of a bit pattern. By transmitting state change information in the form of an interrupt, it can be ensured that the comparator state, which is only present at the comparator circuit for a short period of time and in particular is not stored, is read sufficiently promptly.

With regard to the example with the threshold values a. to d.: A state bit can be assigned to each of the threshold values in the comparator circuit of the power supply. So for the four cases a. to d. there are four state bits in the comparator circuit. The four state bits can be connected to an integrated circuit in the power supply unit (I/O to PC decoder), which can be connected to the computing equipment of the mobile ticketing device via the I²C interface respectively the bus system.

In case of (in particular each) exceeding and/or falling below the e.g. applied voltage according to cases a. to d., a bit change (e.g., from 0 to 1) of the respective assigned state bit is initiated by means of the comparator circuit. Via the I²C interface respectively the corresponding bus system, this bit change can trigger an interrupt in the computing equipment of the mobile ticketing device. Thereupon, in particular the generation unit of the computing equipment can read the comparator state from the power supply via the PC interface, i.e., in particular which state bit is “toggled”, i.e., which threshold value is exceeded or falling below.

The described hardware-based logic is advantageously based on four simple yes/no information bits that can be quickly generated and recorded. Additional (four) state bits of the I²C interface may be available for further threshold values.

According to a further embodiment of the mobile ticketing device according to the application, the generation unit may be configured to generate the at least one measurement data set only upon receipt of a changed comparator state. The generation of data sets that are hardly useful for an evaluation can thus be omitted. The energy requirement can be reduced.

The generated measurement data set may contain the at least one received comparator state (e.g., the at least one “toggled” state bit) as at least one electrical parameter datum, a generation time datum (in particular a timestamp with calendar date and preferably at least time accurate to the second), and in particular a ticketing device identifier. Such a measurement data set can subsequently be evaluated in a simple manner. In particular, the ticketing device identifier enables a (one-to-one) identification of the mobile ticketing device in which the measurement data set was generated.

The generated measurement data set can preferably additionally contain a vehicle identifier of the transport vehicle in which the mobile ticketing device is installed. In this case, the vehicle identifier must be entered in the operating data of the respective mobile ticketing device. This makes it possible to determine a correlation between failed ticketing devices and transport vehicles, in particular the corresponding transport vehicle types, in the evaluation. Measures can then be taken for the mobile ticketing devices installed in such a vehicle type.

The at least one generated measurement data set may preferably be (temporarily) stored in a data memory of the mobile ticketing device. The output module may be configured to output the at least one stored measurement data set, in particular to a background system and/or a mobile terminal, as has already been described.

In particular, in case no vehicle identifier is contained in the measurement data set, according to a further embodiment, a background system of the passenger transportation system may comprise at least one data memory configured at least to store an operation database. The operation database may contain respective mappings between ticketing device identifiers and vehicle identifiers, for example in the form of a mapping table. In particular, the at least one ticketing device identifier of the at least one ticketing device installed in a specific transport vehicle may be associated with the vehicle identifier of the specific transport vehicle. This may identify the transport vehicle in which the mobile ticketing device in which the measurement data set was generated is installed.

Optionally, it may further be provided that a measurement data set may contain further data, such as a connector equipment identifier of the electrical connector equipment of the mobile ticketing device.

According to a further preferred embodiment of the mobile ticketing device, the computing equipment may comprise at least one evaluation unit. The evaluation unit, which can in particular be integrated in the computing equipment, can be configured to evaluate a plurality of the generated (and in particular stored) measurement data sets. The evaluation of the plurality of generated measurement data sets may comprise at least a determining of the disturbance duration. For example, a disturbance duration can be determined as the comparator state, in particular the bit pattern, is determined both at an occurrence of the disturbance (e.g., falling below a threshold value) and at an end of the disturbance (e.g., exceeding the (same) threshold value). Alternatively or additionally, the evaluation unit can periodically request the comparator state after receiving an interrupt (until a response from the comparator circuitry indicates that it has changed again).

In order to obtain further evaluation options and in particular to enable more precise evaluations, according to a further embodiment of the mobile ticketing device according to the application, an intelligent electrical measuring module (in particular an intelligent voltage measuring module) can be integrated in the mobile ticketing device (instead of the measuring module described above together with the I²C bus system).

Preferably, the electrical measuring module can be configured to at least almost continuously detect the electrical parameter values applied to the connector equipment. In particular, a nearly continuous measuring is performed by regularly sampling (e.g., every ⅕ second) the applied analog parameter signal, such as an analog voltage signal. The electrical measuring module can generate digital measurement values by the sampling.

The generation unit, preferably integrated in the electrical measuring module, may be configured to generate the at least one measurement data set containing the at least one parameter datum and at least one generation time datum.

The parameter datum (e.g., a voltage datum) may be based on at least one of the measured parameter values. For example, a measurement data set may contain as a parameter datum the at least one measured parameter value. Also, a measurement datum may contain a plurality of measured parameter values or may contain as a parameter datum an average of a plurality of measured parameter values.

As has been described, the electrical measuring module may be an intelligent electrical measuring module. According to a preferred embodiment, the electrical measuring module may comprise a computing unit (e.g., comprising a microcontroller). The computing unit may be configured to compare the measured parameter values with at least one first parameter comparison range and one second parameter comparison range (different from the first parameter comparison range). A parameter comparison range may be defined by at least one parameter limit value stored in a data memory of the mobile ticketing device, for example each by an upper parameter limit value and a lower parameter limit value. In particular, a parameter comparison range may be a voltage comparison range and the at least one stored parameter limit value may be a voltage limit value.

Exemplary voltage comparison ranges defined by at least one voltage limit value are shown in Table 1 below for a mobile ticketing device having an exemplary 12 V nominal voltage and a design range between 11.0 V and 14.0 V:

TABLE 1

| Voltage | |
|---|---|
| comparison range | |
| defined by at least | |
| one voltage | |
| limit value (in V) | Explanation |
| 40 and more | The overvoltage protection is |
| | triggered from the voltage limit |
| | value 40 V onwards |
| 15.6 . . . 18.0 | |
| 14.1 . . . 15.5 | |
| 11.0 . . . 14.0 | Design range |
| 10.9 . . . 9.5 | |
| 9.4 and less | From the voltage limit value 9.4 V |
| | the power supply is deactivated |

The generation unit can be configured to generate the at least one measurement data set at least when (preferably only when) a parameter range change of the measured parameter values from the first parameter comparison range to the second parameter comparison range or from the second parameter comparison range to the first parameter comparison range is detected by the computing unit. This further facilitates a downstream evaluation of the measurement data sets.

The at least one data memory of the mobile ticketing device can be configured to (temporarily) store the at least one measurement data set, preferably of each measurement data set.

The generation unit may generate a measurement data set for each first parameter value. It shall be understood that a measurement data set may also comprise two or more parameter values. In particular, the generation unit may be configured to refrain from generating a measurement data set if no range change is detected. In other words, a measurement data set is preferably generated only when a parameter range change of the measured parameter values from a first parameter comparison range to a second parameter comparison range or from the second parameter comparison range to the first parameter comparison range is detected by the computing unit. Data that would be at least less important for a subsequent evaluation cannot be generated in the first place. The monitoring effort can be reduced.

Alternatively, the generation unit can be configured to reduce a generation frequency of the measurement data sets during a time period in which no range change is detected.

For example, a generating and storing respectively recording may be omitted for measured applied voltage values respectively input voltages that remain entirely within a design range of the mobile ticketing device. Alternatively, in this case, the generation frequency respectively recording frequency can be reduced, in particular by generating respectively recording a voltage measurement data set with an average voltage value as the voltage datum for a period without exceeding the limit value or range change. For example, a voltage value can be recorded once per minute if the measurements within this minute do not provide input voltages that are outside the design range.

According to a preferred embodiment of the mobile ticketing device according to the application, each parameter comparison range may be associated with at least one minimum time period stored in the data memory. Following the example of Table 1, for example, the following assignment may be stored in the data memory in the form of an assignment table.

TABLE 2

| Voltage comparison range | Minimum | |
|---|---|---|
| defined by at least one voltage | time period | |
| limit value (in V) | (in seconds) | Explanation |
| 40 and more | 0 | overvoltage protection is |
| | | triggered as of the voltage |
| | | limit value 40 V |
| 15.6 . . . 18.0 | 2 | |
| 14.1 . . . 15.5 | 5 | |
| 11.0 . . . 14.0 | ∞ | design range |
| 10.9 . . . 9.5 | 1 | |
| 9.4 and less | 0.5 | from the voltage limit value |
| | | 9.4 V the power supply is |
| | | deactivated |

The electrical measuring module can preferably comprise at least one timing device. The timing device may be configured to measure a time period from a detection of a parameter range change. In other words, immediately upon respectively after a detection of a parameter range change, the timing device respectively timer is started.

The generation unit may be configured to generate the at least one measurement data set at least if (preferably only if) the time period measured by the timing device from the detection of the parameter range change is greater than or equal to the minimum time period associated with the parameter comparison range to which the measured parameter values have changed.

For example, if a parameter range change from the design range (11.0 V to 14.0 V) to the adjacent parameter comparison range “14.1 V to 15.5 V” has been detected, the timing device can be started. If the measured applied voltage changes back to the design range within the minimum time period (e.g., 5 seconds) assigned to the range to which the measured voltage values have changed, the generation unit can be configured to refrain from generating a measurement data set. Thus, in particular, no range change is detected.

If the measured applied voltage does not change back to the design range within the minimum time period (e.g., 5 seconds), the generation unit can be configured to generate a corresponding measurement data set. In particular, a range change is detected. In particular, a measurement data set can only be generated if the measured applied voltage does not change back to the original parameter comparison range within a minimum time period.

According to a further embodiment of the mobile ticketing device according to the application, the mobile ticketing device may comprise at least one communication unit (described above). In particular, the communication unit is configured to receive a change data set (from e.g., a background system) containing at least one changed parameter limit value and/or at least one changed minimum time period. The data memory may be configured to update the at least one stored parameter limit value and/or the at least one stored minimum time period based on the received change data set.

As will be described, a change data set may be generated depending on an evaluation of the previously generated (historical) measurement data sets. Based on an evaluation result, a stored parameter limit value can be increased or reduced, a further parameter comparison range can be added or deleted, and/or the minimum time period can be increased or reduced. In particular, this enables the provision of an individual monitoring and/or a group monitoring of mobile ticketing devices in a simple manner.

Individual mobile ticketing devices or groups of mobile ticketing devices, in particular those for which a higher error frequency has been determined by the evaluation, can for example be configured to monitor and in particular record their respective input voltages more closely (e.g., by adding parameter comparison ranges and/or by reducing at least one minimum time period) than other “unproblematic” mobile ticketing devices for which, for example, parameter comparison ranges can be deleted and/or a minimum time period can be/is increased.

The data memory can alternatively or additionally be configured to store the sampling rate of the electrical measuring module, i.e., in particular to store the frequency with which the analog and time-continuous electrical signal applied at the electrical connector equipment, in particular the voltage signal, is sampled in a predetermined period of time, i.e., in particular measured and converted into a time-discrete signal. The change data set may alternatively or additionally contain a changed sampling rate. The data memory may be configured to update the at least one stored sampling rate based on the received change data set, which in particular contains the changed sampling rate. Again, this may provide a close monitoring or less close monitoring, if required.

According to a further embodiment of the mobile ticketing device according to the application, the electrical measuring module may comprise at least one first (internal) data interface. The first data interface may be configured to exchange data with a second (internal) data interface of the computing equipment of the mobile terminal. The computing equipment may comprise the communication unit.

As has already been described, according to a further embodiment, the data memory may be integrated in the electrical measuring module. The data memory may be configured to temporarily store the at least one generated measurement data set.

According to a further embodiment, the first data interface can be configured to transmit the measurement data sets stored in this data memory, in particular at specific times (e.g., periodically, for example every minute or every hour), and/or after a detected parameter range change, and/or after a storing of a specific number of measurement data sets, and/or upon a request by the computing equipment.

The output module (preferably comprising the communication unit), which is preferably integrated in the computing equipment or communicatively connected thereto, can be configured to output the transmitted measurement data sets, in particular to transmit these measurement data sets to a background system, in particular at specific times (e.g. periodically, for example every minute or every hour), or after a parameter range change, or after storing of a specific number of measurement data sets, or upon a request by the computing equipment, or when a communication link to the background system is present.

Preferably, the at least one measurement data set can be transmitted to a background system when (anyway) further data (e.g., stored sales data) are transmitted to the background system. In the case of mobile ticketing devices, this can usually be the case during shift changes in bus depots, operation depots and/or in a destination station, in which case existing radio data networks (e.g., WLAN) of the transport company in particular can be used for the transmission.

The communication unit can preferably be selected from the group comprising WLAN communication unit and mobile radio communication unit.

According to a particularly preferred embodiment of the ticketing device according to the application, the mobile ticketing device may further comprise at least one environment sensor. The environment sensor may be, for example, a temperature sensor. The environment sensor may be configured to detect at least one environmental parameter (e.g., an ambient temperature) of the mobile ticketing device.

Further, the ticketing device may comprise at least one first creating unit (for example, implemented in the computing equipment) configured to create at least one first sensor parameter data set containing at least the detected environmental parameter value (e.g., the measured temperature) and a detection time datum (in particular, a time stamp with calendar date and preferably at least time accurate to the second), and in particular, a ticketing device identifier. The detection frequency of the environment sensor may be predetermined. Preferably, a first measurement data set may be created and stored for each detected environmental parameter value, for example in said data memory.

In particular, it has been recognized that (older) vehicle batteries at a low ambient temperature may be a reason of electrical problems in transport vehicles and/or the at least one mobile ticketing device installed therein. By detecting and in particular recording the ambient temperature, correlations between the detected temperature, for example when the mobile ticketing device is switched on (measured temperature=outside temperature=battery temperature), and parameter range changes can provide helpful information during an evaluation.

Furthermore, “normal” parameter range changes can also be detected during evaluation and, in particular, processed respectively evaluated correctly in statistical terms, as they occur, for example, during starting processes of bus motors, since these are closely related in time to the switching on of the ticketing device, for example. A timing device can be used for this purpose, for example. For example, a short-term drop in the input voltage during a bus engine starting process can be ignored when evaluating the electrical measurement data sets.

Alternatively or additionally, the mobile ticketing device may further comprise at least one component event sensor. The component event sensor may be configured to detect at least one component event respectively a component operating state of a component (e.g., printer, money acceptance and exchange equipment, etc.) of the mobile ticketing device. In particular, a component event means whether a component is performing a particular task/activity (e.g., a printing operation, a bill collection operation, etc.).

Further, the mobile ticketing device may comprise at least one second creating unit. The second creating unit (which may also be formed by the first creating unit) may be configured to create at least one second sensor parameter data set containing at least the detected component event (printing operation, collection operation, etc.) and a detection time datum (in particular a time stamp with calendar date and preferably at least time accurate to the second) and in particular a ticketing device identifier. The detection frequency of the component event sensor may be predetermined. Preferably, a second set of measurement data may be created and stored for each component event detected, for example in said data memory.

By detecting and in particular recording component events, correlations between parameter range changes and activities/events of the mobile ticketing device can be determined as part of an evaluation, for example the printing of a ticket during a parameter range change or the processing of a banknote during a parameter range change.

According to a further preferred embodiment of the mobile ticketing device according to the application, the mobile ticketing device may comprise an operating parameter adjustment module. The operating parameter adjustment module may be configured to adjust at least one operating parameter value of an operating parameter (e.g., a printing parameter, such as printing speed, printing temperature, printing resolution, power consumption, etc., an operating parameter of the money acceptance and exchange equipment, such as a feeding speed of a bill feeder, power consumption, etc.) of a component of the mobile ticketing device based on an evaluation of the at least one measurement data set and, in particular, the at least one first sensor parameter data set and/or the at least one second sensor data set.

For example, if a (temporal) correlation between a parameter range change (e.g., to a parameter comparison range other than the design range) and a printing operation performed by a printer of the mobile ticketing device is detected by an evaluation (by an evaluation module), the operating parameter adjustment module may be configured to adjust a printing parameter. After an adjustment of the printing parameter, it can then be checked whether the adjustment has led to an improvement of the situation (for example, no temporal correlation between parameter range change and print operation can be detected). If so, the printing parameter can be retained. Otherwise, for example, a further adjustment of the printing parameter or another printing parameter can be made.

For example: a mobile ticketing device may, for example, have a printer as a component configured to create, in particular to print and to issue, paper-based ticket media in the form of tickets. The printer may be, for example, a thermal printer. A thermal printer is configured to print on thermal paper by applying heat. The printing speed and the electrical power consumption of the thermal printer thereby depend substantially linearly on each other within operating limits.

If it is now determined by the described monitoring, recording and evaluating of the applied voltage and the printing processes as component events in a mobile ticketing device that the applied voltage always collapses to a critical value (i.e., a parameter range change is detected) when the printer is printing, then the operating parameter adjustment module (e.g., a device controller) can reduce the operating parameter power consumption respectively current consumption of the printer during printing, e.g., from 6 A to 3 A. This also reduces the printing speed, i.e., it takes longer to issue a paper-based ticket. However, as a consequence, the mobile ticketing device can be operated possibly more stable with regard to its unfavorable power supply, if necessary.

Such an adjustment can be logged as a technical process, in particular in the mobile ticketing device, and stored in the data memory with ticketing device identifier, date, time, error code and/or the like, in order to be retrievable, for example, by a mobile terminal with a service application for a service technician and/or to be transmitted to the background system for downstream evaluating and reporting.

It is further conceivable that such an adjustment can be performed for a limited time duration, for example for the remainder of a day, and that thereafter the adjustment is cancelled again until the need for a new adjustment arises again.

It is further conceivable that the parameters for such an adaptation (trigger criteria, reaction parameters) are adjustable and adaptable in the computing equipment respectively the corresponding software.

A further aspect of the application is a (previously described) passenger transport system. The passenger transport system comprises at least one mobile ticketing device installed in a transport vehicle, as previously described. The passenger transport system comprises at least one background system comprising at least one communication module. The output module of the mobile ticketing device is configured to transmit the at least one measurement data set to the communication module.

The background system (also referred to as backend system) may be formed by at least one computing device, for example in the form of a server. For example, a plurality of distributed computing devices may be provided. Also, a cloud system may be implemented as the background system.

The passenger transport system may comprise the at least one transport vehicle, preferably a plurality of transport vehicles. In variants of the application, the passenger transport system may comprise at least one mobile terminal, in particular of a service technician. The mobile terminal may in particular comprise a service application, which may be set up according to the background system.

According to a preferred embodiment of the passenger transport system according to the application, the background system may comprise at least one evaluation module configured to evaluate the at least one transmitted measurement data set. In particular, the evaluation may be performable as has been described before. Preferably, the transmitted (and stored in the background system) historical measurement data sets of preferably a plurality of mobile ticketing devices can be evaluated regularly and/or at specific times. In particular, the evaluation module may be configured to identify correlations, for example, between parameter range changes and certain types of transport vehicles or between threshold value exceedings or threshold value fallings below and certain types of transport vehicles and/or the like. For example, the evaluation module may be configured to determine individuals of the mobile ticket devices for which a frequency of transmitted measurement data sets is detected. This frequency may be determined by comparing the number of all transmitted measurement data sets of all mobile ticketing devices within an evaluation time period. Thus, for example, the specific individuals can be considered separately in a reliability evaluation of the transport vehicles of the passenger transport system and/or targeted service actions on the transport vehicles or specific mobile ticketing devices can be derived where the frequency occurs.

According to a further preferred embodiment of the passenger transport system according to the application, the output module of the mobile ticketing device may be configured to transmit the at least one first sensor parameter data set and/or the at least one second sensor parameter data set to the communication module of the background system. In particular, the evaluation module may be configured to evaluate the at least one transmitted measurement data set and the at least one first sensor parameter data set and/or the at least one second sensor parameter data set. The evaluating may comprise determining at least one parameter datum, in particular at least one parameter range change, that correlates in time to at least one sensor parameter value based on the at least one detection time datum and the at least one generation time datum (as has been described in particular previously). In a corresponding manner, threshold exceedings or threshold fallings below can be evaluated.

According to a further preferred embodiment of the passenger transportation system according to the application, the background system may comprise an operating parameter change module. The operating parameter change module may be configured to generate an operating parameter data set based on the evaluation result of the evaluation module. In particular, a printing parameter and/or an operating parameter of the cash receiving and changing equipment may be adjusted by the operating parameter change module. The communication module of the background system may be configured to transmit the generated operating parameter data set to the at least one mobile ticketing device. In particular, the operating parameter data set may be transmitted to the at least one mobile ticketing device for which the adjustment of the at least one operating parameter is to be made in order to eliminate or at least reduce an electrical problem detected in the evaluation of that mobile ticketing device.

As has already described above, an operating parameter data set can also be transmitted to a specific group of mobile ticketing devices that are, for example, all installed in the same type of vehicle. In principle, all mobile ticketing devices can also be updated almost simultaneously by transmitting the operating parameter data set.

Said operating parameter adjustment module of the mobile ticketing device that has received an operating parameter data set can then adjust the at least one operating parameter (value) based on the received operating parameter data set (i.e., based in particular on the described evaluation).

As described above, a mobile terminal respectively the service application installed thereon may also comprise said modules of the background system in a form appropriately adapted for the mobile terminal.

A still further aspect is a method for monitoring a mobile ticketing device, in particular a mobile ticketing device according to any one of the preceding claims, in particular in a previously described passenger transport system, comprising:
measuring, by at least one electrical measuring module, an electrical parameter applied at an electrical connector equipment of the mobile ticketing device,
generating, by at least one generation unit, at least one measurement data set containing at least one electrical parameter datum about the measured electrical parameter, and
outputting, by at least one output module, the generated measurement data set, in particular to a background system.

A module (e.g., evaluation module, measuring module, etc.), an equipment (e.g., computing equipment, etc.), a unit (e.g., generation unit, computing unit, etc.), or a device may be formed, in the present case, at least in part from software and/or at least in part from hardware. In particular, a device/module may comprise suitable computing elements (e.g., processor, memory, etc.) to execute software elements (or computer code). It should also be noted that terms such as “first”; “second”, etc. do not indicate an order, but are used in particular to distinguish between two elements.

The features of the mobile ticketing devices, passenger transport systems and methods can be freely combined with each other. In particular, features of the description and/or of the dependent claims may be independently inventive, even by completely or partially bypassing features of the independent claims, in sole position or freely combined with each other.

### BRIEF DESCRIPTION OF THE DRAWINGS

There are now a multitude of possibilities for designing and further developing the mobile ticketing device according to the application, the passenger transport system according to the application and the method according to the application. In this regard, reference is made on the one hand to the claims subordinate to the independent claims, and on the other hand to the description of embodiment examples in connection with the drawing. The drawings show:

FIG. 1 a schematic view of an embodiment of a mobile ticketing device according to the present application,

FIG. 2 a schematic view of a further embodiment of a mobile ticketing device according to the present application,

FIG. 3 a schematic view of a further embodiment of a mobile ticketing device according to the present application,

FIG. 4 a schematic view of an embodiment of a passenger transport system according to the present application, and

FIG. 5 a diagram of an embodiment of a method according to the present application. Similar elements are hereinafter designated by similar reference signs.

### DETAILED DESCRIPTION OF SPECIFIC EMBODIMENTS

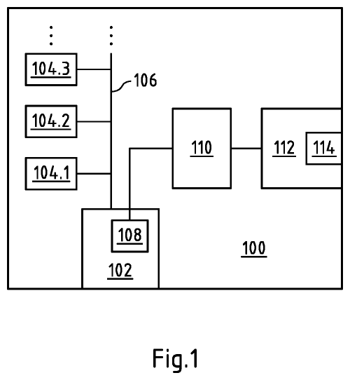

FIG. 1 shows a schematic view of an embodiment of a mobile ticketing device 100 according to the present application. The mobile ticketing device 100 may in particular be a ticket vending machine or a farebox. In an intended operation, the mobile ticketing device 100 may be fixedly respectively permanently installed in a transport vehicle by means of at least one (not shown) mechanical connector equipment. A mobile ticketing device 100 is generally configured at least to issue a ticket medium respectively a ticket.

The mobile ticketing device 100 comprises an electrical connector equipment 102. The electrical connector equipment 102 is used to connect respectively electrically couple the mobile ticketing device 100 to an electrical on-board supply system of a transport vehicle. Through this, the electrical energy respectively power required for the operation of the at least one electrical consumer 104.1, 104.2, 104.3 respectively the at least one electrically operated component 104.1, 104.2, 104.3 (three consumers 104.1, 104.2, 104.3 respectively components 104.1, 104.2, 104.3 are shown by way of example in the present case) of the mobile ticketing device 100 can be provided to the mobile ticketing device 100.

In particular, an electrical parameter (also referred to as input parameter) is applied at the electrical connector equipment 102 (in particular a power supply unit), in particular a voltage (also referred to as input voltage).

Components 104.1, 104.2, 104.3 may comprise, for example, a printer 104.1, in particular a thermal printer, a money acceptance and exchange equipment 104.2, for example with an electric motor for feeding in banknotes, a display 104.3 and/or the like. These components 104.1, 104.2, 104.3 may be connected to the electrical connector equipment 102 via an internal power supply 106.

According to the application, the mobile ticketing device 100 comprises at least an electrical measuring module 108, a generation unit 110 and an output module 112.

Preferably, the electrical measuring module 108 may be integrated in the electrical connector equipment 102. The electrical measuring module 108 is configured to measure at least one electrical parameter applied at the electrical connector equipment 102, such as the applied voltage and/or the flowing current.

Preferably, the electrical measuring module 108 may be a voltage measuring module 108. In the following embodiments, it is exemplarily assumed that the electrical measuring module 108 is a voltage measuring module 108 configured to measure the applied voltage. It shall be understood that the following embodiments are transferable to current measuring modules or the like.

The generation unit 110 is configured to generate at least one measurement data set containing at least one electrical parameter datum, by way of example a voltage datum, about the measured electrical parameter, by way of example the applied voltage. The voltage datum may be the (actually) measured voltage or an event associated with the measured voltage, in particular triggered by the measured voltage. For example, the voltage datum may be an information that a certain voltage threshold has been exceeded or fallen below by the measured voltage.

The output module 112 is configured to output the generated measurement data set, in the present example the voltage data set. In particular, the output module 112 may comprise a communication unit 114 configured to transmit the at least one voltage data set to a background system and/or a mobile terminal, for example of a service technician.

Exemplary and non-exhaustive mobile terminals in this regard comprise smartphones, tablet computers, mobile gaming consoles, laptops, netbooks, data glasses, smart watches, and similar wearables. In variants of the application, an outputting may also comprise a displaying of the at least one voltage data set by a display of the mobile ticketing device.

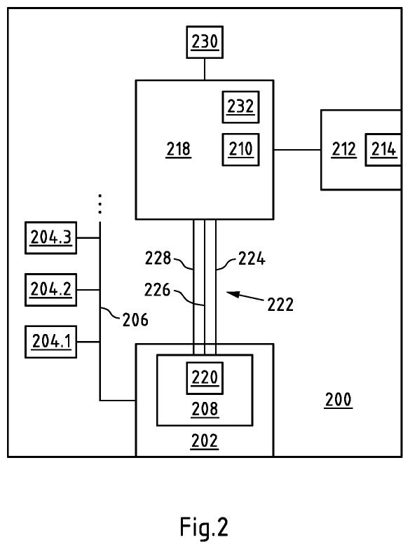

FIG. 2 shows a schematic view of a further embodiment of a mobile ticketing device 200 according to the present application. In order to avoid repetitions, essentially only the differences to the embodiment according to FIG. 1 are described below, and otherwise reference is made to the previous explanations.

In addition to the already described at least one component 204.1 to 204.3, which can be connected to the electrical connector equipment 202, for example in the form of a power supply unit 202, via an internal power supply network 206, as well as a generation unit 210 and an output module 212, for example with a communication unit 214, the mobile ticketing device 200 in the present application comprises at least one comparator circuit 220, which is connected to a computing equipment 218 of the mobile ticketing device 200 via a bus system 222.

The computing equipment 218 respectively controller equipment 218 of the mobile ticketing device 200 may be (generally) configured to control the mobile ticketing device 200, in particular the components 204.1 to 204.3. As can be further seen, the computing equipment 218 may preferably comprise the generation unit 210. Optionally, the computing equipment 218 may comprise an evaluation unit 232 configured to evaluate a plurality of the voltage data sets generated by the generation unit 210, in particular by determining the disturbance duration based on the generated voltage data sets.

Preferably, the mobile ticketing device 200 may comprise at least one data memory 230 accessible by the computing equipment 218. In particular, the data memory 230 may be configured to (temporarily) store the generated voltage data sets. In addition, further data may be stored in the data memory 230, such as sales data about tickets sold by the mobile ticketing device 200, evaluation results of the evaluation unit, etc.

The bus system 222 is preferably an I²C bus system. In the present case, the illustrated bus system 222 comprises an interrupt line 224, a data line 226 and a clock line 228.

In particular, the comparator circuit 220 is configured to compare the voltage value applied at the electrical connector equipment 202 with at least one predetermined voltage threshold value, in the present example with four voltage threshold values. By way of example, the following (previously described) voltage threshold values may be (fixedly) provided: a. 9 V, b. 11 V, c. 22 V, d. 40 V.

Preferably, the comparator circuit 220 is configured to (temporarily) change a comparator state upon detection of an exceeding and/or falling below of the exemplary voltage threshold values by the measured applied electrical parameter. In particular, in the comparator circuit 220, each voltage threshold value can be assigned to (exactly) one state bit which (temporarily) changes its value upon detection of an exceeding and/or falling below of the assigned voltage threshold value.

In particular, immediately after a change in the comparator state has occurred, the comparator circuit 220 can transmit a state change information via the bus system 222. In particular, the state change information indicates (only) that the comparator state has changed. Preferably, a change that has occurred in a comparator state, i.e., a change in the value of one of the state bits (e.g., from 0 to 1), causes a transmitting of an interrupt (as a state change information) via the interrupt line 224 to the computing equipment 218.

The reception of an interrupt in the computing equipment 218 has in particular the effect of interrupting a task that may have just been executed. In particular, the computing equipment 218 is configured as a master and is configured to (immediately) initiate a transmission of the changed comparator state via the data line 226 upon a receipt of the interrupt. For example, the comparator state may be requested from the comparator circuit 220 via the data line 226. In response, the comparator circuit 220, which is configured as a slave, sends the instantaneous comparator state, in particular the instantaneous state bit pattern, to the computing equipment 218.

Upon a receipt of the comparator state, the generation unit 210 may in particular generate the voltage measurement data set containing at least the received comparator state as a voltage datum. Preferably, in addition, the voltage measurement data set may contain a generation time datum (in particular, a timestamp having a calendar date and preferably at least a time accurate to the second) and, in particular, a ticketing device identifier.

The ticketing device identifier can uniquely identify the mobile ticketing device 200 at least in the passenger transportation system respectively system-wide. As has been described, according to variants of the application a vehicle identifier may be additionally contained. The vehicle identifier may uniquely identify the transport vehicle in which the mobile ticketing device 200 is installed, at least in the passenger transport system respectively system-wide.

As has been described, a generated voltage measurement data set may be temporarily stored in the data memory 230. The optional evaluation unit 232 may evaluate the voltage measurement data set.

Alternatively or additionally, an evaluation may be performed by a background system and/or a mobile terminal of a service technician, as will be described. For this purpose, in particular the output module 212 can transmit the stored voltage measurement data sets to the background system and/or the mobile terminal device, for example at specific times (e.g. periodically, for example every minute or every hour), and/or after a detected threshold value has been exceeded or fallen below, and/or after a specific number of voltage measurement data sets have been stored in the data memory 230.

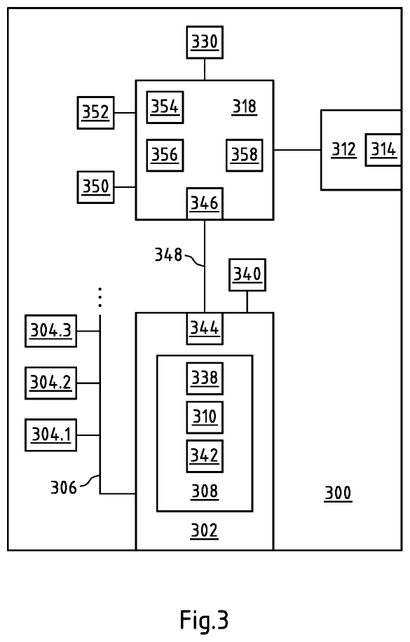

FIG. 3 shows a schematic view of a further embodiment of a mobile ticketing device 300 according to the present application. In order to avoid repetitions, substantially only the differences to the embodiment according to FIG. 2 are described below and otherwise reference is made to the previous embodiments.

An essential difference between the embodiment according to FIG. 2 and the embodiment according to FIG. 3 is that instead of a comparator circuit, which merely compares the voltage value of an analog voltage signal with at least one threshold value and can merely indicate whether the at least one threshold value has been exceeded or fallen below, the voltage measuring module 308 is presently designed as an intelligent voltage measuring module 308 comprising in particular a computing unit 338 (in particular with a processor) for processing (digital) voltage measurement data.

The voltage measuring module 308 is presently configured in particular to sample the applied analog voltage signal, preferably with a predetermined (configurable) sampling frequency. For example, the predetermined sampling frequency may be stored in a data memory 340 of the mobile ticketing device. In other words, the voltage measuring module 308 may be configured to at least almost continuously detect respectively measure the voltage values applied at the connector equipment 302 by sampling the applied analog voltage signal, in particular at regular intervals (e.g., every ⅕ second).

By way of example two data memories 330, 340 are shown herein. In variants of the application, only one data memory or more than two data memories may also be provided.

As can be further seen from FIG. 3, in this embodiment, the generation unit 310 may be integrated in the voltage measuring module 308. The generation unit 310 may be configured to generate the at least one voltage measurement data set containing at least one voltage datum and at least one generation time datum. In particular, the voltage datum is based on the measured voltage values. For example, a voltage measurement data set may comprise as a voltage datum a measured respectively recorded voltage value, a plurality of measured respectively recorded (successive in time) voltage values, an average voltage value of a plurality of measured respectively recorded (successive in time) voltage values, or the like.

The at least one generated voltage measurement data set may be temporarily stored in the data memory 340. Via a data link 348 between a first data interface 344 of the electrical connector equipment 302 and a second data interface 346 of the computing equipment 318, stored voltage measurement data sets may be transmitted to the computing equipment 318, for example periodically (e.g., minutely or hourly), and/or after a detected voltage range change, and/or after a certain number of voltage measurement data sets have been stored in the data memory 340, and/or upon a request by the computing equipment 318.

The optional and preferred computing unit 338 may be configured to compare the measured voltage values with at least a first voltage comparison range and a second voltage comparison range, which may be different from the first voltage comparison range. A voltage comparison range may be defined by at least one voltage limit value (see, for example, Table 1 or 2).

Preferably, a voltage measurement data set may be generated by the generating unit 310 at least when the computing unit 338 has detected a voltage range change by the comparison. In particular, the voltage measurement data set may contain as a voltage datum an information about the voltage range change (e.g., that a change from a first range to a second range has occurred).

For example, it can be provided that a voltage measurement data set is only generated when a voltage range change has been detected. Also, it may be provided that voltage data sets are generated whenever the measured voltage values are outside the design range.

Optionally, a timing device 342 may be provided which can be configured to measure a time duration from a detection of a voltage range change. A voltage range change can then only be detected if the measured voltage values are within the new voltage range for a certain minimum time period without changing back to the original voltage range (see also Table 2).

A minimum time period and/or a voltage limit value, in particular a corresponding table (or the like), may be configurably stored in the data memory 340.

In particular, the communication unit 314 may be configured to receive a change data set containing at least one changed voltage limit value and/or at least one changed minimum time period and/or at least one changed sampling frequency. The change data set may be based, in particular, on an evaluation of historical voltage measurement data sets and possibly further data.

The data memory 340 (or also 330) may then be configured to update the at least one stored parameter limit value and/or the at least one stored minimum time period and/or the at least one changed sampling frequency based on the received change data set. Then, the mobile ticketing device 300 may continue to operate according to the updated data.

Further, the mobile ticketing device 300 may optionally comprise at least one sensor 350, 352. By way of example, an environment parameter sensor 352, for example in the form of a temperature sensor 352, and a component event sensor 350 are provided in the mobile ticketing device 300. The temperature sensor 352 is configured to detect the ambient temperature, for example, with a specific detecting frequency (e.g., every minute).

A first creating unit 354, preferably implemented in the computing equipment 318, may be configured to generate a temperature data set containing at least the measured temperature and a detection time datum (in particular a time stamp with calendar date and preferably at least exact time to the second) and in particular a ticketing device identifier and/or a vehicle identifier.

In a preferred embodiment of the application, a temperature data set (or other first parameter data set) may be generated only when a voltage range change is detected by the computing unit 338 and/or the measured voltage is outside the design range.

In particular, the at least one component event sensor 350 is used to monitor and detect activity/events of at least one of the components 304.1, 304.2, 304.3, which may be supplied with electrical power via the internal power network 306. In other words, a component event sensor 350 may be configured to detect at least one component event of a component 304.1, 304.2, 304.3 of the mobile ticketing device 300.

For example, in the case of a printer 304.1, at least each printing event may be detected by the at least one component event sensor 350. Additionally or alternatively, at least one other component event may be detected, such as the power consumption during a printing operation. For example, in a bill accepting and changing equipment 304.2, at least each bill feed-in, which may be performed by an electric motor, for example, may be detected. In the case of a display 304.3, for example, it may be detected whether the display is activated or in an idle mode.

A second creating unit 356, preferably implemented in the computing equipment 318, may be configured to generate at least one second sensor parameter data set containing at least the detected component event and a detection time datum (in particular a time stamp having a calendar date and preferably at least a time to the second) and in particular a ticketing device identifier and/or a vehicle identifier. For example, each activity respectively event of the at least one electrically operated component 304.1, 304.2, 304.3 may be detected and recorded in the form of a second sensor parameter data set.

In a preferred variant of the application, a second sensor parameter data set may be generated only if a voltage range change is detected by the computing unit 338 and/or the measured voltage is outside the design range (and an event respectively activity is detected; in further variants, it may also be provided that a second sensor parameter data set is generated even if no activity respectively event is detected when a voltage range change has occurred, such sensor parameter data set containing corresponding information that no event was detected).

Furthermore, the mobile ticketing device 300, preferably the computing equipment 318, may comprise an operating parameter adjustment module 358 configured to adjust at least one operating parameter value of an operating parameter of a component 304.1, 304.2, 304.3 of the mobile ticketing device 300, in particular based on an evaluation of the at least one measurement data set and in particular the at least one first sensor parameter data set and/or the at least one second sensor data set. The operational parameter may be a parameter that can be detected by the described component event sensor.

For example, for a printer 304.1, the current respectively power consumption may be adjusted. The same can be done for a money acceptance and exchange equipment 304.2 (for example, a banknote feed in can be (temporarily) deactivated; payment can then only be possible with coinage or by means of a bank card or the like) and/or a display 304.3 (for example, the brightness can be reduced).

In particular, the communication unit 314 may be configured to receive an operating parameter data set containing at least one changed operating parameter value. Additionally, an operating parameter data set may preferably contain a time indication about the period of validity of the at least one changed operating parameter value. The operating parameter adjustment module 358 may then initiate an adjustment of the corresponding operating parameter value based on the received operating parameter data set.

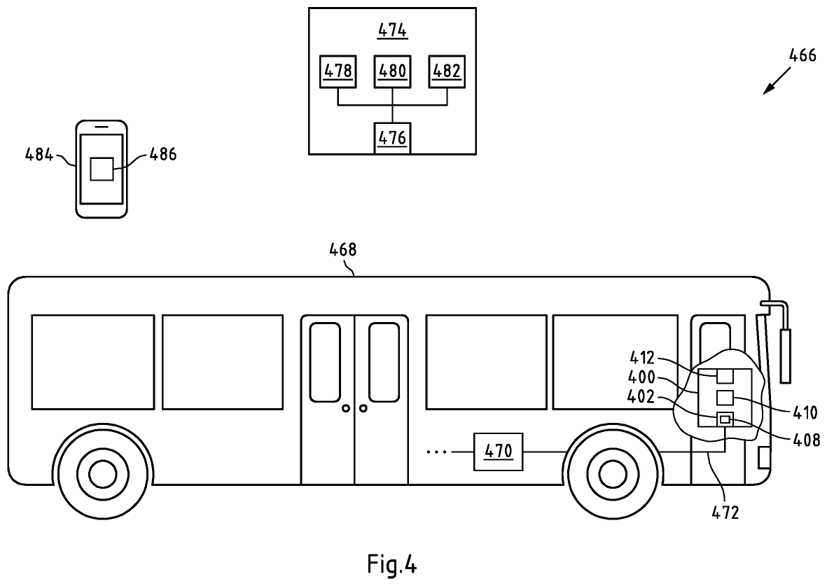

FIG. 4 shows a schematic view of an embodiment of a passenger transport system 466. The passenger transport system 466 comprises at least one mobile ticketing device 400. In particular, for the sake of clarity, only the electrical connector equipment 402 comprising a voltage measuring module 408, a generation unit 410, and an output module 412 of the mobile ticketing device 400 are shown. The mobile ticketing device 400 may be formed according to FIG. 1 and/or FIG. 2 and/or FIG. 3. In particular, the mobile ticketing device 400 may be a farebox.

Furthermore, the passenger transport system 466 comprises at least one background system 474. The background system 474 may be formed by at least one computing device, for example in the form of a server. For example, a plurality of distributed computing devices may be provided. Also, a cloud system may be implemented as the background system 474.

Preferably, the passenger transport system 466 comprises at least one transport vehicle 468, in particular a plurality of transport vehicles 468. Merely by way of example, the transport vehicle 468 is shown as a bus in which the mobile ticketing device 400 is permanently installed.

Optionally, the passenger transportation system 466 may comprise at least one mobile terminal 484 (e.g., a smartphone and/or a tablet computer) with a service application 486 installed thereon. In particular, the service application 486 (also referred to as an app) may function in a similar way to the elements 478, 480, 482 of the background system 474 described below.

The shown mobile ticketing device 400 is connected to the on-board supply system 472 of the transport vehicle 468 by means of the electrical connector equipment 402. The transport vehicle 468 may comprise at least one vehicle battery 470 configured to supply electrical energy respectively power to the mobile ticketing device 400 and, in particular, to a plurality of other electrical loads (not shown) of the transport vehicle 468.

The background system 474 may comprise at least one communication module 476 configured at least to exchange data with the at least one mobile ticketing device 400. In particular, the output module 412 of the mobile ticketing device 400 may be configured to transmit the at least one measurement data set to the communication module 476, as described above. Optionally, further data may be transmitted by the output module 412 to the communication module 476, such as the described sales data sets, first and/or second sensor parameter data sets, evaluation data sets, etc.

In addition to the communication module 476, the background system 474 may comprise a data memory 478 in particular for storing received data sets, an evaluation module 480, and in particular an operating parameter change module 482.

The at least one evaluation module 480 may be configured to evaluate the at least one transmitted measurement data set, in particular the plurality of historical data sets stored in the data memory 478. For example, the evaluation module 480 may be configured to determine individuals of the mobile ticket devices 410 for which a frequency of transmitted measurement data sets is detected. This frequency may be determined by comparing the number of all transmitted measurement sets of all mobile ticketing devices 410 within an evaluation time period. This may, for example, allow the determined individuals to be considered separately in a reliability evaluation of the transportation vehicles 468 (fleet of devices) of the passenger transportation system and/or allow targeted service actions to be derived on the transportation vehicles 468 or particular mobile ticketing devices 410 where the frequency occurs.

Further and/or alternatively, for example, a correlation between certain types of transportation vehicles and certain detected parameter range changes respectively occurred failures may be determined in the evaluation process. Alternatively to detected parameter range changes, threshold exceedings and threshold fallings below may also be evaluated.

When a correlation is determined between a specific transport vehicle type and, for example, a specific detected parameter range change, the operating parameter change module 482 may be configured to generate an operating parameter data set comprising at least one changed operating parameter. Preferably, this operating parameter data set may be transmitted to all mobile ticketing devices 400 through the communication module 476 that are installed in a transport vehicle that corresponds to the identified transport vehicle type.

It shall be understood that, in variants of the application, a transmitting of such an operational parameter data set may also be initially made to a single mobile ticketing device 400 to initially verify the effectiveness of the at least one changed operational parameter (prior to a comprehensive rollout) at a single mobile ticketing device 400.

The evaluation module 480 may preferably be configured to evaluate the at least one transmitted measurement data set and the at least one first sensor parameter data set and/or the at least one second sensor parameter data set. The evaluating may comprise determining of at least one parameter datum that is temporally correlated to at least one sensor parameter datum based on the at least one detection time datum and the at least one generation time datum.

When a temporal correlation is determined between a specific component event and a specific detected parameter range change (respectively threshold exceeding or threshold falling below), the operating parameter change module 482 may be configured to generate an operating parameter data set comprising at least one changed operating parameter. This operating parameter data set may preferably be transmitted to all mobile ticketing devices 400 by the communication module 476.

Again, it shall be understood that in variants of the application, a transmitting of such an operational parameter data set may first be made to a single mobile ticketing device 400 to first verify the effectiveness of the at least one changed operational parameter (prior to a comprehensive rollout) at a single mobile ticketing device 400.

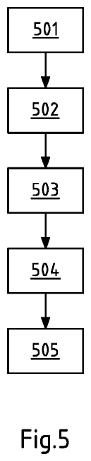

FIG. 5 shows a diagram of a method for monitoring a mobile ticketing device, in particular a mobile ticketing device according to FIGS. 1, 2, 3 and/or 4.

In a step 501, a measuring is performed, by at least one electrical measuring module, of an electrical parameter applied at an electrical connector equipment of the mobile ticketing device, as has already been described.

In step 502, a generating is performed, by at least one generation unit, of at least one measurement data set containing at least one electrical parameter datum about the measured electrical parameter, as has already been described.

In step 503, an outputting is performed, by at least one output module, of the generated measurement data set, in particular to a background system, as has already been described.

Optionally, in step 504, an evaluating of the output measurement data set can be carried out, as previously described, in particular taking into account further sensor measurement data.

Furthermore, optionally in step 505, at least one operating parameter value of a component of the mobile ticketing device can be adjusted based on the performed evaluation, as has already been described.

Steps 501 to 505 may be performed at least partially in parallel and, in particular, repetitively. In particular, after an adjustment of the at least one operating parameter, it can be checked whether an improvement of the measured input voltage can (or cannot) be achieved thereby. Depending on the result of the check, a further adjustment of the at least one operating parameter can be carried out.

### LIST OF REFERENCE SIGNS

100 mobile ticketing device
102 electrical connector equipment
104 components
106 internal power supply
108 electrical measuring module
110 generation unit
112 output module
114 communication unit
200 mobile ticketing unit
202 electrical connector equipment
204 component
206 internal power supply
210 generation unit
212 output module
214 communication unit
218 computing equipment
220 comparator circuit
222 bus system
224 interrupt line
226 data line
228 clock line
230 data memory
232 evaluation unit
300 mobile ticketing device
302 electrical connector equipment
304 component
306 internal power supply
308 voltage measuring module
310 generation unit
314 communication unit
318 computing equipment
330 data memory
338 computing unit
340 data memory
342 timing device
344 first data interface
346 second data interface
348 data link
350 component event sensor
352 environment parameter sensor
354 first creating unit
356 second creating unit
358 operating parameter adjustment module
400 mobile ticketing device
402 electrical connector equipment
408 voltage measuring module
410 generation unit
412 output module
466 passenger transport system
468 transport vehicle
470 vehicle battery
472 on-board supply system
474 background system
476 communication module
478 data memory
480 evaluation module
482 operating parameter change module
484 mobile terminal
486 service application

What is claimed is:

1. A mobile ticketing device for a transport vehicle of a passenger transport system, comprising:
at least one electrical connector equipment configured to connect the mobile ticketing device to an electrical on-board supply system of the transport vehicle;
at least one electrical measuring module configured to measure an electrical parameter applied at the electrical connector equipment;
at least one generation unit configured to generate at least one measurement data set containing at least one electrical parameter datum about the measured electrical parameter; and
at least one output module configured to output the generated measurement data set.

2. The mobile ticketing device according to claim 1, wherein
the electrical measuring module comprises a comparator circuit integrated in the connector equipment, wherein the comparator circuit is configured to compare the parameter value applied at the electrical connector equipment with at least one predetermined electrical threshold value,
the comparator circuit is configured to change a comparator state upon detection of the measured applied electrical parameter exceeding and/or falling below the at least one electrical threshold value, and
wherein the comparator circuit is configured to transmit a state change information to a computing equipment of the mobile ticketing device comprising the at least one generation unit when the comparator state has been changed.

3. The mobile ticketing device according to claim 2, wherein
the comparator circuit is connected to the computing equipment via a bus system,
the bus system comprises at least one interrupt line and one data line,
the comparator circuit is configured to transmit the state change information to the computing equipment by sending an interrupt via the interrupt line, and
the computing equipment is configured to initiate a transmission of the changed comparator state via the data line to the computing equipment upon a receipt of the interrupt.

4. The mobile ticketing device according to claim 2, wherein
the at least one generation unit is configured to generate the at least one measurement data set only upon a receipt of a changed comparator state,
the generated measurement data set contains as at least one electrical parameter datum, the at least one received comparator state and a generation time datum.

5. The mobile ticketing device according to claim 2, wherein
the computing equipment comprises at least one evaluation unit configured to evaluate a plurality of the generated measurement data sets,
the evaluating of the plurality of generated measurement data sets comprises at least a determining of the disturbance duration.

6. The mobile ticketing device according to claim 1, wherein
the at least one electrical measuring module is configured to at least almost continuously detect the electrical parameter values applied at the connector equipment, and
the at least one generation unit is integrated in the at least one electrical measuring module and is configured to generate the at least one measurement data set containing the at least one parameter datum and at least one generation time datum,
the parameter datum is based on at least one of the measured parameter values.

7. The mobile ticketing device according to claim 6, wherein
the at least one electrical measuring module comprises a computing unit configured to compare the measured parameter values with at least one first parameter comparison range and one second parameter comparison range,
a parameter comparison range is defined by at least one parameter limit value stored in a data memory of the mobile ticketing device, and
the at least one generation unit is configured to generate the at least one measurement data set at least when a parameter range change of the measured parameter values from the first parameter comparison range to the second parameter comparison range or from the second parameter comparison range to the first parameter comparison range is detected by the computing unit.

8. The mobile ticketing device according to claim 7, wherein
at least one minimum time period stored in the data memory is associated with each parameter comparison range, and
the at least one electrical measuring module comprises at least one timing device configured to measure a time period from a detection of a parameter range change,
the at least one generation unit is configured to generate the at least one measurement data set at least if the measured time period from the detection of the parameter range change is greater than or equal to the minimum time period associated with the parameter comparison range into which the measured parameter values have changed.

9. The mobile ticketing device according to claim 8, further comprising
at least one communication unit configured to receive a change data set containing at least one changed parameter limit value and/or at least one changed minimum time period, and
the data memory is configured to update the at least one stored parameter limit value and/or the at least one stored minimum time period based on the received change data set.

10. The mobile ticketing device according to claim 1 further comprising
at least one environment sensor configured to detect at least one environmental parameter of the mobile ticketing device, and
at least one first creating unit configured to generate at least one first sensor parameter data set containing at least the detected environmental parameter value and a detection time datum,
and/or
at least one component event sensor configured to detect at least one component event of a component of the mobile ticketing device, and
at least one second creating unit configured to create at least one second sensor parameter data set containing at least the detected component event and a detection time datum.

11. The mobile ticketing device according to claim 10 further comprising
an operating parameter adjustment module configured to adjust at least one operating parameter value of an operating parameter of a component of the mobile ticketing device based on an evaluation of the at least one measurement data set and in particular the at least one first sensor parameter data set and/or the at least one second sensor data set.

12. A passenger transport system, comprising:
at least one mobile ticketing device installed in a transport vehicle according to claim 1; and
at least one background system comprising at least one communication module,
wherein the output module of the mobile ticketing device is configured to transmit the at least one measurement data set to the communication module.

13. The passenger transport system according to claim 12, wherein
the background system comprises at least one evaluation module configured to evaluate the at least one transmitted measurement data set.

14. The passenger transport system according to claim 13, wherein
the evaluation module is configured to determine individuals of the mobile ticketing devices at which a frequency of transmitted measurement data sets is detected.

15. The passenger transport system according to claim 13, wherein
the output module is configured to transmit the at least one first sensor parameter data set and/or the at least one second sensor data set to the communication module, and
the evaluation module is configured to evaluate the at least one transmitted measurement data set and the at least one first sensor parameter data set and/or the at least one second sensor parameter data set,
the evaluating comprises determining at least one parameter datum that correlates in time to at least one sensor parameter value based on the at least one detection time datum and the at least one generation time datum.

16. The passenger transportation system of claim 15, wherein
the background system comprises an operating parameter change module configured to generate an operating parameter data set based on the evaluation result of the evaluation module, and
the communication module is configured to transmit the generated operating parameter data set to the at least one mobile ticketing device.

17. A method for monitoring a mobile ticketing device, comprising:
measuring, by at least one electrical measuring module, an electrical parameter applied at an electrical connector equipment of the mobile ticketing device,
generating, by at least one generation unit, at least one measurement data set containing at least one electrical parameter datum about the measured electrical parameter, and
outputting, by at least one output module, the generated measurement data set.

18. The method according to claim 17, wherein
outputting comprises outputting, by the at least one output module, the generated measurement data set to a background system.

19. The mobile ticketing device according to claim 4, wherein
the generated measurement data set contains as at least one electrical parameter datum, the at least one received comparator state, a generation time datum, and a ticketing device identifier.

20. The mobile ticketing device according to claim 11, wherein
the operating parameter adjustment module is configured to adjust the at least one operating parameter value of an operating parameter of a component of the mobile ticketing device based on an evaluation of the at least one measurement data set and the at least one first sensor parameter data set and/or the at least one second sensor data set.
